(19) United States
(12) Patent Application Publication
(10) Pub. No.: US 2005/0212434 A1
(43) Pub. Date: Sep. 29, 2005

(54) Lamp for a vehicle headlight with low-beam function

(75) Inventors: Klaus Schoeller, Nideggen (DE); Colette Knight, Aachen (DE); Ralf Schaefer, Aachen (DE); Lukas Kuepper, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/502,184

(22) PCT Filed: Dec. 2, 2003
(86) PCT No.: PCT/IB03/05588

§ 371 Date: Jul. 21, 2004

(30) Foreign Application Priority Data
Dec. 10, 2002 (EP) 02102711.5

(51) Int. Cl. H01J 61/35

(52) U.S. Cl. 313/635

(57) ABSTRACT

The invention relates to a lamp for a vehicle headlight with low-beam function, which lamp has an outer envelope (4) and emits at least visible light of different colors from several regions of the outer envelope (4), characterized in that in that a partial coating (2) is at least provided on the outer envelope (4) such that, when the low-beam function is being realized, at least that region of the traffic space which lies above the bright-dark cut-off can be at least partly illuminated with visible colored light which is scattered at said partial coating (2), while at the same time that region of the traffic space which lies below the bright-dark cut-off can be illuminated with visible light of a different color in defined regions.

The invention relates to a lamp for a vehicle headlight with low-beam function, which lamp has an outer envelope and emits at least visible light of different colors from several regions of the outer envelope.

The expression “outer envelope” relates to the outermost envelope in the case of lamps having several envelopes and, in the case of lamps having only a single envelope, to this single envelope within the context of the present invention.

Vehicle headlights with low-beam function in the context of the invention are all those headlights which generate a bright-dark cut-off, such as, for example, pure low-beam headlights, combined high- and low-beam headlights, pure fog headlights, combined low-beam and fog headlights, and curve illumination headlights.

Lamps used for this field of application are incandescent lamps, in particular halogen lamps with one or two incandescent filaments, or high-pressure gas discharge lamps. Lamps to be used in vehicle headlights are subject to international standards as regards their main parameters such as, for example, the SAE or ECE standards, which relate in particular to the European or the US market. For example, the color properties to be achieved are exactly defined for all cases.

Usually, headlights with a low-beam function are fitted with lamps which radiate visible light of substantially the same color in all spatial directions, so that in that case usually a traffic space illuminated with a homogeneous color is obtained.

The respective desired and/or required light color can be achieved by means of conventional coatings which are provided in particular on the outer surface of the outer envelope of the lamp in a known manner.

It is known that bluish light is better reflected against obstacles in the traffic space, for example traffic signs, and can thus be better or earlier observed in particular by the driver of the vehicle illuminating the respective traffic space, so that the traffic safety is usually enhanced thereby. Yellow light, by contrast, leads to a lower glare sensitivity on the part of a driver of an oncoming vehicle. It is furthermore known that the human eye has not only an achromatic sensitivity, which can be described inter alia by the standardized sensitivity curve V(λ), but also a chromatic sensitivity which depends extremely strongly on the parameters of ambient lighting and duration of glare. The chromatic sensitivity in the blue spectral range depends very strongly on the duration of a glare-generating illumination. For example, if the duration of the glare rises from 5 ms to 1 s, the spectral sensitivity of the eye is raised fivefold. This is true in particular for the peripheral vision regions of the eye under mesoscopic viewing conditions. Mesoscopic viewing conditions obtain when the color-sensitive (daylight vision) and the color-insensitive (night vision) visual cells are addressed to the same degree. Color-sensitive visual cells are predominantly addressed in daylight vision and color-insensitive visual cells in night vision.

The integral spectral intensity distribution of a high-pressure gas discharge lamp, such as a so-termed xenon lamp, is two to three times higher in the short-wave (blue) spectral range than that of a halogen lamp. Experiments with test subjects led to the result that the luminance of a halogen lamp must be 25 to 50% higher than the luminance of a xenon lamp so as to achieve the same glare effect. A reduction of the luminance of a xenon lamp in the short-wave (blue) spectral range, and accordingly a reduction in glare of oncoming drivers, can be adjusted by means of a yellow coating on the lamp envelope. Such yellow coated xenon or halogen lamp envelopes are known.

U.S. Pat. No. 5,578,893 discloses a halogen lamp for a vehicle headlight which has two incandescent wires and which is capable of realizing both the low-beam and the high-beam function. One incandescent wire, i.e. the low-beam incandescent wire, is arranged adjacent the tip of the glass bulb, and the second, high-beam incandescent wire is arranged adjacent the pinch of the glass bulb. A region impermeable to light at the tip of the outer envelope merges into a coated region which is in communication with the low-beam incandescent wire which is arranged adjacent the tip of the glass bulb and which exclusively serves the low-beam function. The homogeneous coating is dimensioned and arranged as regards its size and shape such that it is ensured that the light emitted by the low-beam incandescent wire must pass substantially fully through this coated region in order to be able to leave the lamp. When the low-beam function is realized, therefore, the light emitted by this incandescent wire passes almost exclusively through said coated region of the outer bulb. This coating, which absorbs in the blue spectral range, is chosen such that the visible light issuing to the exterior has in particular a yellowish color. When the low-beam function is realized, the entire traffic space then illuminated by the vehicle is accordingly homogeneously illuminated with yellowish light. The advantages of a bluish light, however, cannot be utilized when the low-beam function is realized. Obstacles or traffic signs present at the right-hand road side, i.e. seen in the driving direction of the vehicle in the case of right-hand traffic, are difficult to observe for the driver of the vehicle.

In the prior art, furthermore, two different types of vehicle headlights are distinguished, i.e. projection and reflection headlights. Only projection headlights have offered the possibility until now of illuminating the traffic space inhomogeneously as regards color. This direction-dependent colored illumination of the traffic space is caused in particular by the projection lens and not by the lamp itself. Such headlights cause a glare effect owing to white or blue stray light in the region above the bright-dark cut-off, which is perceived as unpleasant by oncoming drivers. Projection headlights sometimes have a brightness-enhancing optical system, which cause additional white or blue stray light.

It is an object of the invention to provide a lamp with such a coating or a lighting device with such a lamp which can be efficiently manufactured in an industrial mass manufacturing process and which renders possible a better traffic safety when the low-beam function is realized without increasing the glare sensitivity.

The object of the invention is achieved in that a partial coating is at least provided on the outer envelope such that, when the low-beam function is being realized, at least that region of the traffic space which lies above the bright-dark cut-off can be at least partly illuminated with visible colored light which is scattered at said partial coating, while at the same time that region of the traffic space which lies below the bright-dark cut-off can be illuminated with visible light of a different color in defined regions.

A partial coating, which does not cover the entire region from which the emitted light issues from the outer envelope of the lamp during realization of the low-beam function in the context of the invention, may be homogeneous or inhomogeneous in particular as regards the layer structure, thickness, and composition in dependence on the desired function of the coating or of the portions of the coating. Such a coating may consist of several different portions according to the invention, which portions are arranged on the outer envelope in a defined manner in dependence on their respective functions.

In countries with right-hand traffic such as, for example, Germany, the partial coating is to be chosen and arranged according to the invention in such a manner that, viewed in the driving direction of the vehicle, the right-hand road side or in particular the outermost region thereof is illuminated with bluish light, whereas the left-hand road side is illuminated with yellowish light, while the region above the bright-dark cut-off is illuminated with yellowish scattered light. The lamp according to the invention thus combines the advantages of the known lamps, which have a full coating in this respect for influencing the light color when the low-beam function is realized. The glare sensitivity of oncoming traffic is reduced, while at the same time an improved visibility of objects in the peripheral visual range is achieved for the right-hand and left-hand road sides. The invention is equally well applicable to left-hand traffic, with suitable modifications.

It is preferred in particular that the partial coating or at least a portion of this coating is an absorption coating which transmits in particular yellow light. Dichroic coatings extending over the entire lamp envelope often lead to a direction-dependent color distribution which causes a stronger glare for the oncoming traffic than an absorption coating, which is usually undesirable.

By contrast, partial dichroic coatings cause a substantially lesser glare arising from uncontrolled reflected light. It is accordingly useful in certain cases that the partial coating or a portion of this coating is an interference coating or a combined absorption and interference coating. This may be the case, for example, if the color point of the pigments used lies outside the color regions standardized in the SAE or ECE guidelines. A suitable interference coating is capable of shifting the color distribution into the desired color range.

It is furthermore preferred that at least a portion of the partial coating on the outer envelope is arranged in a striped pattern extending substantially parallel to the axis of the light source or along the pinstripes. If lamps with so-termed pinstripes are used, which serve to screen off that light that would dazzle the oncoming traffic, a striped arrangement of the partial coating along the pinstripes achieves that the traffic space below the bright-dark cut-off is illuminated with bluish light. Blue light leads to a substantially earlier recognition of traffic signs or any obstacles in the traffic space, in particular in the peripheral visual range along the bright-dark cut-off.

It is furthermore preferred that a partial coating, in particular a yellow absorption layer, is arranged in a defined manner, in particular on the frontmost region of the lamp envelope. This region extends preferably from the lamp tip up to the end of the return lead. The yellow light scattered against the pigments of this coating is not imaged in defined regions of the traffic space, but rather is scattered over the entire traffic space, i.e. also into the high-beam distance. Yellow scattered light in the glare region of the high-beam space is superimposed on the other scattered light such that oncoming drivers experience a reduced glare impression because of the lower sensitivity of the eye in the yellow spectral range.

It is furthermore preferred that the partial coating comprises at least a portion which is an absorption coating, from which in particular yellow light is issued and which is arranged in the frontmost and/or rearmost region of the lamp envelope, and a portion which is arranged in a striped pattern along the pinstripes and from which in particular blue light is issued.

The invention is furthermore achieved in a lighting unit which comprises at least one lamp as claimed in the claims 1 to 7.

Further particulars, features, and advantages of the invention will become apparent from the ensuing description of two preferred embodiments, which is given with reference to the drawing, in which:

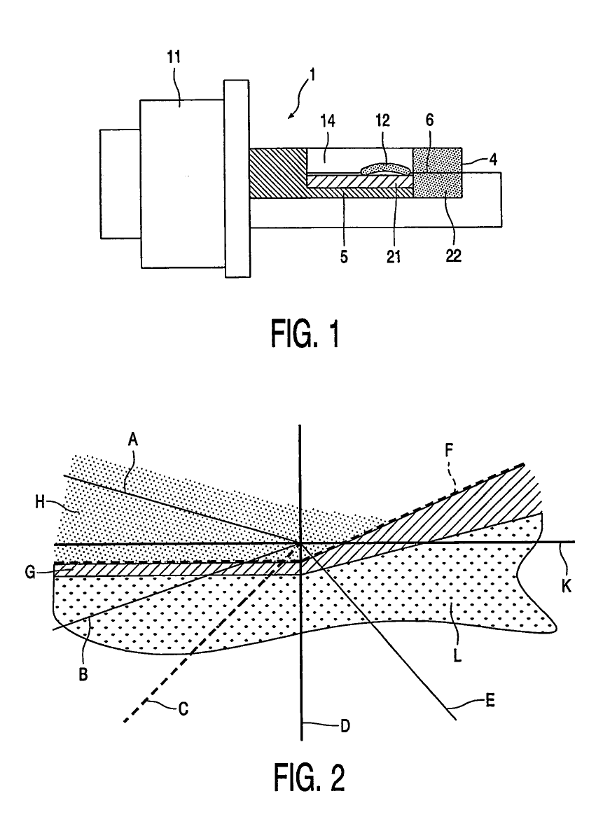

FIG. 1 is a diagrammatic side elevation of a xenon lamp for a reflection headlight,

FIG. 2 diagrammatically shows an illumination distribution in the traffic space of a lamp of FIG. 1,

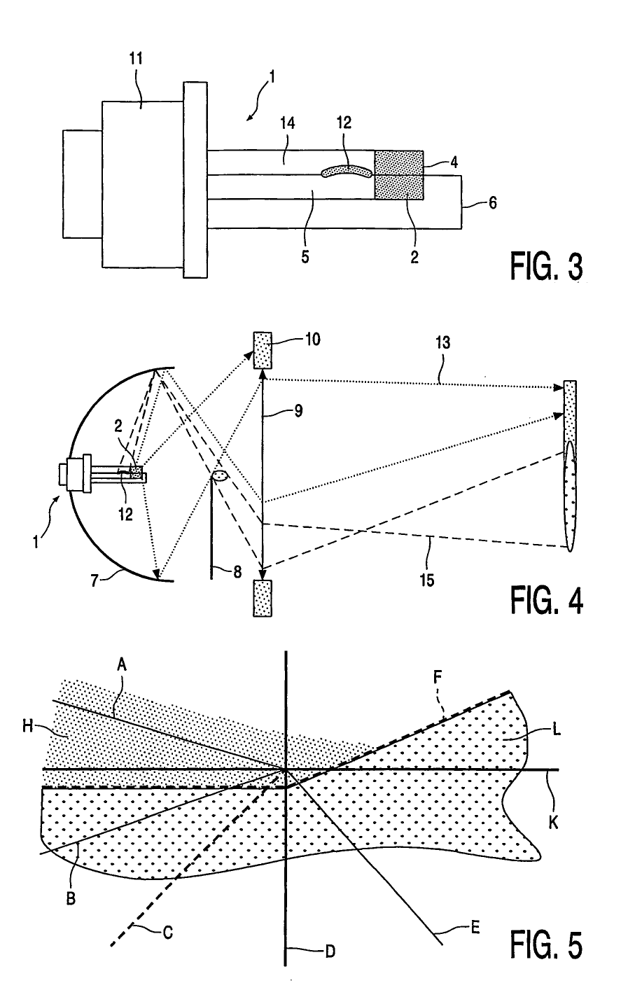

FIG. 3 is a diagrammatic side elevation of a xenon lamp for a projection headlight,

FIG. 4 is a diagrammatic picture of a xenon lamp in a projection headlight, and

FIG. 5 diagrammatically shows the illumination distribution in the traffic space of a lamp of FIG. 3.

FIG. 1 is a diagrammatic side elevation of a first embodiment of a xenon lamp 1 according to the invention for a reflection headlight. A luminous discharge arc 12 is diagrammatically shown in FIG. 1 as the actual light source inside the lamp envelope 3, which is connected to a lamp base 11. The luminous discharge arc 12 is formed in a known manner between the two electrodes, the electrode remote from the lamp base 11 being denoted the return lead 6. The partial coating 2 comprises the portions 21 and 22 and is arranged in total only on a portion of the outer surface of the outer envelope 4. Two pinstripes 5, of which only one pinstripe 5 is visible in FIG. 1, are arranged on the outer envelope 4, and in their immediate vicinity there are two striped portions 21 of the partial coating 2, of which only one striped portion is visible in FIG. 1. The outer envelope 4 in addition has a region 14 which has no coating, so that unfiltered light issues predominantly from this region. The portion 22 of the partial coating 2 is formed by an absorption coating.

The coating 2 is a so-termed sol-gel coating in which organic or inorganic pigments are embedded in a silicon dioxide network. Depending on the desired color impression and the desired temperature stability of the coating 2, mixtures of different pigments may alternatively be used. In addition to solvents such as, for example, diacetyl alcohol necessary for the deposition, the use of means for supporting an optimum cross-linking is useful, such as, for example, pigments mixed with an alkoxysilane compound.

The requirements imposed on the temperature stability of the partial coating 2 are determined in particular by the temperatures of 900 to 950° C. to which the outer envelope 4 of the high-pressure discharge lamp is regularly exposed. Pigments complying with these requirements and generating a blue color impression through the two striped portions 2 are, for example, pigments comprising Co—Al. A good transparency and a low stray light component are achieved inter alia when the particle size of the pigments is preferably below 100 nm.

The coating 2 is provided in a known pressure spraying process in a known manner. After the coating process, it is favorable to allow the coating 2 to cure for 5 to 10 minutes at approximately 250° C.

Alternatively to the portion 21, a blue multiple-layer interference filter may be provided along the pinstripes 5 on the surface of the outer envelope 4 in a sputter coating process. The width of the stripe should preferably be less than or equal to 3 mm.

FIG. 2 diagrammatically shows the illumination distribution of the lamp 1 according to the invention on a vertical screen, for example 10 m in front of the vehicle when the low-beam function is being realized in accordance with FIG. 1. FIG. 2 contains a line A which is the line on which the eyes of a driver of oncoming traffic move; B the line of the left-hand driving lane edge; C the central line of the driving lane; D the line representing the center of the right-hand driving lane; E the line of the right-hand driving lane edge; and F the line of the bright-dark cut-off; with G being the region of the blue stray light which is bounded at the upper side by the line F of the bright-dark cut-off, and with H being the region of the yellow stray light. Light passing through the portion 22 of the partial coating 2 is imaged adjacent the bright-dark cut-off F in the traffic space. K denotes the horizon line, and L the region illuminated by unfiltered light. The bright-dark cut-off F is that region in the traffic space which separates the traffic space illuminated by the headlight from the traffic space not illuminated thereby. A portion of the emitted light incident on the portion 22 is scattered into the glare region, which lies above the bright-dark cut-off F, and is superimposed on the unfiltered stray light of the lamp 1 present there.

FIG. 3 is a diagrammatic side elevation of a further embodiment of a xenon lamp 1 according to the invention for a projection headlight. The partial coating 2 in this embodiment is provided on the surface of the outer envelope 4 in the region between the return lead 6 and the end of the outer envelope 4 in the form of a homogeneous, closed, yellow BiVO4 absorption layer. The pinstripes 5 are also provided on the outer envelope 4. The remaining region of the surface of the outer envelope 4 is substantially formed by a region 14 which has no coating.

FIG. 4 diagrammatically shows a xenon lamp with a partial coating 2 arranged in a projection headlight. The lamp 1 is positioned in an elliptical mirror 7. The lighting unit comprises in addition inter alia a diaphragm 8, a lens 9, and a conventional contrast-reducing optical system 10. FIG. 4 shows the radiation path 15 of that portion of the emitted light that passes through the region 14 with a broken line and the radiation path 13 issuing from the partial coating 2 with a dotted line.

FIG. 5 is a diagrammatic picture analogous to that of FIG. 2 of the illumination distribution in the traffic space of the second embodiment when the low-beam function is being realized.

A portion of the yellow light scattered against the coating 2 also enters the glare region H of the oncoming driver, in contrast to non-scattered, unfiltered light. Since the human eye is less sensitive in the yellow spectral region than in the blue spectral region, the glare effect is clearly weaker in the former region. The light passing through the yellow absorption layer 2 without scattering and portions of the yellow light scattered against the coating 2 enter the traffic space to be illuminated, i.e. the region L in FIG. 5, as does the unfiltered light.

1. A lamp for a vehicle headlight with low-beam function, which lamp has an outer envelope (4) and emits at least visible light of different colors from several regions of the outer envelope (4), characterized in that in that at least a partial coating (2) is provided on the outer envelope (4) such that, when the low-beam function is being realized, at least that region of the traffic space which lies above the bright-dark cut-off can be at least partly illuminated with visible colored light which is scattered at said partial coating (2), while at the same time that region of the traffic space which lies below the bright-dark cut-off can be illuminated with visible light of a different color in defined regions.

2. A lamp as claimed in claim 1, characterized in that the light source of the lamp (1) is a high-pressure discharge lamp or an incandescent lamp, in particular a halogen lamp.

3. A lamp as claimed in claim 1, characterized in that the partial coating (2) or at least a portion of this coating is an absorption coating which scatters in particular yellow light at least partly.

4. A lamp as claimed in claim 1, characterized in that the partial coating (2) or at least a portion of this coating is an interference coating or a combined absorption and interference coating which transmits in particular blue light.

5. A lamp as claimed in claim 1, characterized in that a partial coating, in particular a yellow absorption layer, is arranged in a defined manner in particular on the front or rear region of the lamp's outer envelope (4).

6. A lamp as claimed in claim 1, characterized in that the partial coating (2) comprises at least a portion (21) which is an absorption coating which scatters in particular yellow light at least partly and a portion (22) which is arranged in a striped pattern along the pinstripes (5).

7. A lamp as claimed in claim 6, characterized in that at least one partial coating (2) extending in a striped pattern along the lamp envelope axis transmits bluish light.

8. A lamp as claimed in claim 1, characterized in that, in the realization of the low-beam function, the traffic space can be illuminated in the vicinity of the bright-dark cut-off in a defined manner by light passing through the partial coating (2).

9. A lighting device comprising at least a lamp (1) as claimed in claim 1.
